(19) United States
(12) Patent Application Publication
(10) Pub. No.: US 2026/0285185 A1
(43) Pub. Date: Sep. 24, 2026

(54) Battery Discharge Equipment for Preventing Cascading Fires Among Parked Electric Vehicles

(71) Applicants: The Regents of the University of Michigan, Ann Arbor, MI (US); The University of California, Merced, Merced, CA (US)

(72) Inventors: Anna Stefanopoulou, Ann Arbor, MI (US); Jason Siegel, Ann Arbor, MI (US); Vivian Tran, Ann Arbor, MI (US); Ricardo de Castro, Merced, CA (US)

(21) Appl. No.: 19/573,049

(22) Filed: Mar. 20, 2026

Related U.S. Application Data
(60) Provisional application No. 63/774,883, filed on Mar. 20, 2025.

(51) Int. Cl. B60L 53/62; B60L 53/18; B60L 53/302; B60L 53/67; B60L 58/12; H01M 10/42

(52) U.S. Cl. CPC B60L 53/62; B60L 53/18; B60L 53/302; B60L 53/67; B60L 58/12; H01M 10/425; B60L 2210/40; B60L 2240/545; H01M 2010/4271; H01M 2220/20

(57) ABSTRACT

A charging station for charging and discharging electric vehicles is disclosed. The charging station includes a charging dispenser electrically connected with an electrical source. The charging dispenser can electrically connect with electric vehicles to optionally charge a battery pack of the vehicles. The vehicles include a sensor in the battery pack. The charging station includes an energy dissipation element in electrical communication with the electric vehicles. The charging station includes a controller programmed to: (i) receive electrical signals based on readings from a sensor of the electric vehicles, (ii) determine when one or more of the electrical signals exceeds a safety threshold in one of the vehicles, and (iii) discharge the battery pack of one or more of the other electric vehicles to the energy dissipation element. The sensor can comprise a temperature sensor, and the safety threshold can comprise a temperature threshold indicating thermal runaway of a battery pack.

### CROSS-REFERENCES TO RELATED APPLICATIONS

This application is based on, claims benefit of, and claims priority to U.S. Application No. 63/774,883 filed on Mar. 20, 2025, which is hereby incorporated by reference herein in its entirety for all purposes.

### STATEMENT REGARDING FEDERALLY SPONSORED RESEARCH

Not Applicable.

### FIELD OF THE INVENTION

This invention relates to emergency electric vehicle discharge equipment for discharging one or more battery packs in electric vehicles parked and optionally being charged in a charging station, and to methods for discharging one or more battery packs in electric vehicles parked and optionally being charged in a charging station.

### BACKGROUND

Sales of electric vehicles have greatly increased in recent years, along with the infrastructure to support these vehicles that are dependent on an electrical charging source, such as a charging station. A conventional electric vehicle charging station is shown in FIG. 1.

Looking at FIG. 1, a conventional charging station 100 can be used for charging a plurality of electric vehicles 110, 112, 114, 116, 118. While five electric vehicles are shown, the charging station 100 may be configured to charge two or more vehicles. The charging station 100 includes an electrical source providing an alternating current power output, such as AC bus 120 (e.g., the electrical grid, an energy storage system having AC output, a building, etc.). Charging dispensers 130,132, 134, 136, 138 (electric vehicle supply equipment [EVSE]) are electrically connected with the electrical source 120 via line 139. Each charging dispenser 130, 132, 134, 136, 138 includes a combination connector 140, 142, 144, 146, 148 that integrates a DC cable enabling Level 3 DC charging and an AC cable enabling Level 2 AC charging. An enlarged end view of each combination connector 140,142, 144, 146, 148 is shown. Each of electric vehicles 110, 112, 114, 116, 118 includes a mating connector for its associated combination connector 140, 142, 144, 146, 148. Other connectors may also be suitable for connecting and thereafter charging the electric vehicles 110, 112, 114, 116, 118.

During operation of the conventional charging station 100, heating of the battery pack of one or more of the electric vehicles 110, 112, 114, 116, 118 may cause the battery cells to overheat and cause battery thermal runaway, which can generate toxic smoke, fires, and explosions. In FIG. 1, the battery pack of electric vehicle 114 has undergone battery thermal runaway, which has generated a fire F. Due to the fire F in electric vehicle 114, fire can propagate to all or part (e.g., the battery packs) of neighboring electric vehicles 110, 112, 116, 118, which are parked in close proximity to electric vehicle 114 having the fire F. The fire F may cause the battery cells in the battery packs of neighboring electric vehicles 110, 112, 116, 118 to overheat and cause battery thermal runaway in the battery packs of neighboring electric vehicles 110, 112, 116, 118, which can generate even more toxic smoke, fires, and explosions.

What is needed therefore is equipment and methods for preventing cascading fires among charging electric vehicles parked in proximity to each other at an electric vehicle charging station. Also, there is a need for methods for preventing battery fire reignitions during subsequent emergency response, transportation, and disposal, which may occur due to stranded energy inside of the battery pack.

### SUMMARY

The foregoing needs are met by: (i) emergency electric vehicle discharge equipment according to the present disclosure for discharging one or more battery packs in electric vehicles parked and optionally being charged in a charging station, and (ii) methods according to the present disclosure for discharging one or more battery packs in electric vehicles parked and optionally being charged in a charging station.

In one aspect, the present disclosure provides a charging station for charging a plurality of electric vehicles. The charging station comprises: (a) an electrical source providing an alternating current power output; (b) a charging dispenser electrically connected with the electrical source, wherein the charging dispenser is configured to electrically connect with each of the plurality of electric vehicles to optionally charge a battery pack of each of the plurality of electric vehicles via the alternating current power output from the electrical source, wherein each of the plurality of electric vehicles includes a battery management system and a sensor in the battery pack of each of the plurality of electric vehicles, wherein the sensor of each of the plurality of electric vehicles is in electrical communication with the battery management system of each of the plurality of electric vehicles; (c) an energy dissipation element, wherein the battery pack of each of the plurality of electric vehicles is in a circuit path with the energy dissipation element when the charging dispenser is electrically connected with each of the plurality of electric vehicles, wherein each circuit path includes a switch having a first position in which electricity does not flow from the battery pack of each of the plurality of electric vehicles to the energy dissipation element and a second position in which electricity flows from the battery pack of each of the plurality of electric vehicles to the energy dissipation element, wherein each switch is in the first position when the charging dispenser is electrically connected with each of the plurality of electric vehicles; and (d) a controller in electrical communication with the battery management system of each of the plurality of electric vehicles and each of the switches. The controller is configured to execute a program stored in the controller to: (i) receive, from the battery management system of each of the plurality of electric vehicles, electrical signals based on readings from the sensor of each of the plurality of electric vehicles, (ii) determine when one or more of the electrical signals from a battery management system of one of the plurality of electric vehicles exceeds a safety threshold, and (iii) when the one or more of the electrical signals from the battery management system of the one of the plurality of electric vehicles exceeds the safety threshold, move the switch in the circuit path in another of the plurality of electric vehicles to the second position such that electricity flows from the battery pack of the another of the plurality of electric vehicles to the energy dissipation element. In one embodiment of the charging station, the sensor comprises a temperature sensor, and the safety threshold comprises a temperature threshold that indicates thermal runaway of the battery pack of the one of the plurality of electric vehicles. In one embodiment of the charging station, the another of the plurality of electric vehicles is adjacent to the one of the plurality of electric vehicles.

In one embodiment of the charging station, the controller executes the program stored in the controller to: (iv) when the one or more of the electrical signals from the battery management system of the one of the plurality of electric vehicles exceeds the safety threshold, move the switch in the circuit path in an additional one of the plurality of electric vehicles to the second position such that electricity flows from the battery pack of the additional one of the plurality of electric vehicles to the energy dissipation element. In one embodiment of the charging station, the additional one of the plurality of electric vehicles is adjacent to the one of the plurality of electric vehicles, the another of the plurality of electric vehicles is on a first side of the one of the plurality of electric vehicles, and the additional one of the plurality of electric vehicles is on an opposite second side of the one of the plurality of electric vehicles.

In one embodiment of the charging station, each circuit path includes a variable resistor in electrical communication with the controller, and the controller executes the program stored in the controller to adjust the variable resistor such that a discharge rate from the battery pack of the another of the plurality of electric vehicles to the energy dissipation element is below a thermal runaway onset threshold for the battery pack of the another of the plurality of electric vehicles.

In one embodiment of the charging station, the energy dissipation element comprises an electrical grid. In one embodiment of the charging station, the energy dissipation element comprises an energy storage system. In one embodiment of the charging station, the energy dissipation element comprises a resistor. In one embodiment of the charging station, the energy dissipation element comprises an electrical device of an auxiliary electrical vehicle.

In one embodiment of the charging station, the charging dispenser is configured to electrically connect with a combination connector of each of the plurality of electric vehicles, and each combination connector integrates a DC cable enabling DC charging and an AC cable enabling AC charging, and when the switch in the circuit path in the another of the plurality of electric vehicles is in the second position, electricity flows from the battery pack of the another of the plurality of electric vehicles to the energy dissipation element via the DC cable of the combination connector of the another of the plurality of electric vehicles. In one embodiment of the charging station, when the one or more of the electrical signals from the battery management system of the one of the plurality of electric vehicles exceeds the safety threshold, AC charging is disabled to the another of the plurality of electric vehicles and the electricity flows from the battery pack of the another of the plurality of electric vehicles to the energy dissipation element via the DC cable of the combination connector of the another of the plurality of electric vehicles.

In one embodiment, the charging station further comprises an energy management device having (i) a first conducting path in which electricity flows from the battery pack of the another of the plurality of electric vehicles to the energy dissipation element, (ii) a second conducting path in which electricity flows from the battery pack of the another of the plurality of electric vehicles to a second energy dissipation element, and (iii) a third conducting path in which electricity flows from the battery pack of the another of the plurality of electric vehicles to a third energy dissipation element, wherein the energy dissipation element comprises an electrical grid, the second energy dissipation element comprises an energy storage system, and the third energy dissipation element comprises a resistor, and wherein the energy management device is configured to selectively deliver electricity from the battery pack of the another of the plurality of electric vehicles to one or more of the energy dissipation element, the second energy dissipation element, and the third energy dissipation element.

In one embodiment of the charging station, the first conducting path includes a DC-AC inverter. In one embodiment of the charging station, the controller executes the program stored in the controller to pass a battery pack operating characteristic received from the battery management system of each of the plurality of electric vehicles into a model to estimate a safety metric for the battery pack of each of the plurality of electric vehicles.

In one embodiment of the charging station, the safety metric is a time to thermal runaway or a time to thermal runaway propagation for the battery pack of each of the plurality of electric vehicles. In one embodiment of the charging station, the battery pack operating characteristic is selected from state of charge, maximum temperature, gas concentration, air pressure, humidity, or any combination thereof. In one embodiment of the charging station, the controller executes the program stored in the controller to adjust a discharge rate from the battery pack of the another of the plurality of electric vehicles to the energy dissipation element based on the safety metric. In one embodiment of the charging station, the charging dispenser comprises a plurality of charging dispensers, each charging dispenser being electrically connected with the electrical source and an associated one of the plurality of electric vehicles.

In one embodiment, the charging station further comprises a multiplexer that enables the energy dissipation element to be shared among each of the plurality of electric vehicles. In one embodiment, the charging station further comprises a cooling system in thermal communication with the energy dissipation element.

In another aspect, the present disclosure provides a method for preventing cascading fires in a charging station for charging a plurality of electric vehicles. The method comprises: (a) providing a sensor in a battery pack of each of the plurality of electric vehicles, wherein the sensor of each of the plurality of electric vehicles is in electrical communication with a battery management system of each of the plurality of electric vehicles, wherein the battery pack of each of the plurality of electric vehicles is in a circuit path with an energy dissipation element, wherein each circuit path includes a switch having a first position in which electricity does not flow from the battery pack of each of the plurality of electric vehicles to the energy dissipation element and a second position in which electricity flows from the battery pack of each of the plurality of electric vehicles to the energy dissipation element; (b) electrically connecting each of the plurality of electric vehicles to a charging dispenser of the charging station, wherein each switch being in the first position when the charging dispenser is electrically connected with each of the plurality of electric vehicles; (c) receiving, in a controller in electrical communication with the battery management system of each of the plurality of electric vehicles, electrical signals based on readings from the sensor of each of the plurality of electric vehicles; (d) determining in the controller when one or more of the electrical signals from a battery management system of one of the plurality of electric vehicles exceeds a safety threshold; and (e) when the one or more of the electrical signals from the battery management system of the one of the plurality of electric vehicles exceeds the safety threshold, moving the switch in the circuit path in another of the plurality of electric vehicles to the second position such that electricity flows from the battery pack of the another of the plurality of electric vehicles to the energy dissipation element. In one embodiment of the method, the sensor comprises a temperature sensor, and the safety threshold comprises a temperature threshold that indicates thermal runaway of the battery pack of the one of the plurality of electric vehicles. In one embodiment of the method, another of the plurality of electric vehicles is adjacent to the one of the plurality of electric vehicles.

In one embodiment of the method, step (e) further comprises when the one or more of the electrical signals from the battery management system of the one of the plurality of electric vehicles exceeds the safety threshold, moving the switch in the circuit path in an additional one of the plurality of electric vehicles to the second position such that electricity flows from the battery pack of the additional one of the plurality of electric vehicles to the energy dissipation element. In one embodiment of the method, the additional one of the plurality of electric vehicles is adjacent to the one of the plurality of electric vehicles, the another of the plurality of electric vehicles is on a first side of the one of the plurality of electric vehicles, and the additional one of the plurality of electric vehicles is on an opposite second side of the one of the plurality of electric vehicles.

In one embodiment of the method, each circuit path includes a variable resistor in electrical communication with the controller, and the method further comprises adjusting the variable resistor such that a discharge rate from the battery pack of the another of the plurality of electric vehicles to the energy dissipation element is below a thermal runaway onset threshold for the battery pack of the another of the plurality of electric vehicles.

In one embodiment of the method, the energy dissipation element comprises an electrical grid. In one embodiment of the method, the energy dissipation element comprises an energy storage system. In one embodiment of the method, the energy dissipation element comprises a resistor. In one embodiment of the method, the energy dissipation element comprises an electrical device of an auxiliary electrical vehicle.

In one embodiment of the method, the charging dispenser is configured to electrically connect with a combination connector of each of the plurality of electric vehicles, and each combination connector integrates a DC cable enabling DC charging and an AC cable enabling AC charging, and when the switch in the circuit path in the another of the plurality of electric vehicles is in the second position, electricity flows from the battery pack of the another of the plurality of electric vehicles to the energy dissipation element via the DC cable of the combination connector of the another of the plurality of electric vehicles. In one embodiment of the method, when the one or more of the electrical signals from the battery management system of the one of the plurality of electric vehicles exceeds the safety threshold, AC charging is disabled to the another of the plurality of electric vehicles and the electricity flows from the battery pack of the another of the plurality of electric vehicles to the energy dissipation element via the DC cable of the combination connector of the another of the plurality of electric vehicles.

In one embodiment, the method further comprises (f) providing an energy management device having (i) a first conducting path in which electricity flows from the battery pack of the another of the plurality of electric vehicles to the energy dissipation element, (ii) a second conducting path in which electricity flows from the battery pack of the another of the plurality of electric vehicles to a second energy dissipation element, and (iii) a third conducting path in which electricity flows from the battery pack of the another of the plurality of electric vehicles to a third energy dissipation element, wherein the energy dissipation element comprises an electrical grid, the second energy dissipation element comprises an energy storage system, and the third energy dissipation element comprises a resistor, and wherein the energy management device is configured to selectively deliver electricity from the battery pack of the another of the plurality of electric vehicles to one or more of the energy dissipation element, the second energy dissipation element, and the third energy dissipation element.

In one embodiment, the method further comprises passing, in the controller, a battery pack operating characteristic received from the battery management system of each of the plurality of electric vehicles into a model to estimate a safety metric for the battery pack of each of the plurality of electric vehicles. In one embodiment of the method, the safety metric is a time to thermal runaway or a time to thermal runaway propagation for the battery pack of each of the plurality of electric vehicles. In one embodiment of the method, the battery pack operating characteristic is selected from state of charge, maximum temperature, gas concentration, air pressure, humidity, or any combination thereof.

In one embodiment, the method further comprises adjusting a discharge rate from the battery pack of the another of the plurality of electric vehicles to the energy dissipation element based on the safety metric. In one embodiment of the method, the charging dispenser comprises a plurality of charging dispensers, each charging dispenser being electrically connected with the electrical source and an associated one of the plurality of electric vehicles.

The foregoing and other aspects and advantages of the invention will appear from the following description. In the description, reference is made to the accompanying drawings which form a part hereof, and in which there is shown by way of illustration example embodiments of the invention. Such embodiments do not necessarily represent the full scope of the invention, however, and reference is made therefore to the claims and herein for interpreting the scope of the invention.

### BRIEF DESCRIPTION OF DRAWINGS

FIG. 1 is a schematic diagram representation of a prior art charging station for charging a plurality of electric vehicles.

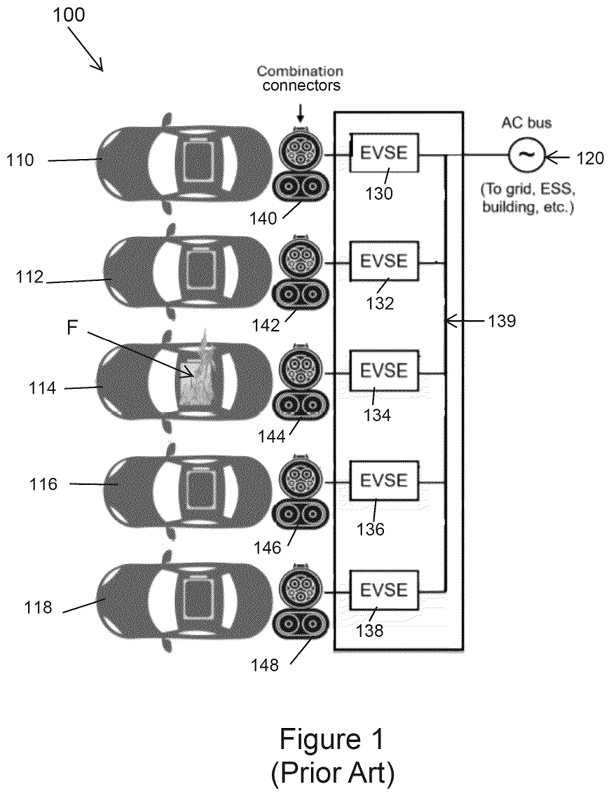

FIG. 2 is a schematic diagram representation of a charging station for charging a plurality of electric vehicles according to one embodiment of the present disclosure.

FIG. 3 is a schematic diagram representation of the controller and energy dissipation system of the charging station of FIG. 2.

Like reference numerals will be used to refer to like parts from Figure to Figure in the following description of the drawings.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown but are to be accorded the widest scope consistent with the principles and features disclosed herein. Skilled artisans will recognize the examples provided herein have many useful alternatives and fall within the scope of embodiments of the invention.

Some disclosure herein refers to “Level 2” and “Level 3” electric vehicle (EV) or plug-in hybrid electric vehicle (PHEV) charging capabilities, which refer to a particular standard defined by the Society of Automotive Engineers. See SAE J1772:2017, Electric Vehicle and Plug in Hybrid Electric Vehicle Conductive Charge Coupler, Society of Automotive Engineers (Oct. 13, 2017) (defining a common EV/PHEV and supply equipment vehicle conductive charging method including operational requirements).

Accordingly, as used herein, the term “Level 2” refers to an EV or PHEV charger having a 208-240 V AC voltage and a 7-19 kW power output, and the term “Level 3” refers to an EV charger having a 400-1,000 V direct current (DC) voltage and a 50-420 kW power output. Further, reference herein to a charging station for an EV is intended to also include reference to such charging station for a PHEV.

The emergency EV discharge equipment and methods described herein prevent cascading EV fires by reducing the battery pack state-of-charge (SOC) and by dissipating the removed energy across multiple endpoints including onboard vehicle loads and offboard charger-integrated loads. Also, the emergency EV discharge equipment and methods described herein can prevent thermal runaway and delay fire propagation in adjacent vehicles by removing a heat source (e.g., a battery pack). As part of the equipment needed to perform an emergency EV discharge, a bidirectional charger (i.e., the charger can also discharge), a controller, and a large, high-power energy dissipation element are introduced to adapt existing EV supply equipment (EVSE) technologies. The following will first explain the working principle and utility of the discharge process. Then, the main components of the emergency EV discharge equipment will be described, including the controller and EVSE energy dissipation element. This includes how the discharge equipment can be integrated with existing technologies and provide additional benefits under normal, non-emergency operations.

The utility of an emergency discharge is built on the concept that both the likelihood and severity of battery thermal runaway, which can generate toxic smoke, fires, and explosions, decrease with decreasing SOC. At the vehicle level, an emergency discharge can address cascading EV-to-EV fire. If a fire occurs within one EV parked in close proximity to others, where all vehicles are potentially at high SOC, a fire can propagate to neighboring EVs. However, if an EV battery pack can be discharged before the fire can propagate, then the reduced heat generation may be low enough to prevent or at least slow the propagation. The second issue this addresses is battery fire reignition during the reverse logistics process of damaged vehicles by bringing the pack down to lower SOC, reducing the safety risks and resource burden on emergency responders, transporters, and recyclers. However, given the comparatively large energy capacity of EV packs, discharging the pack may require dissipating the removed energy across multiple electrical loads.

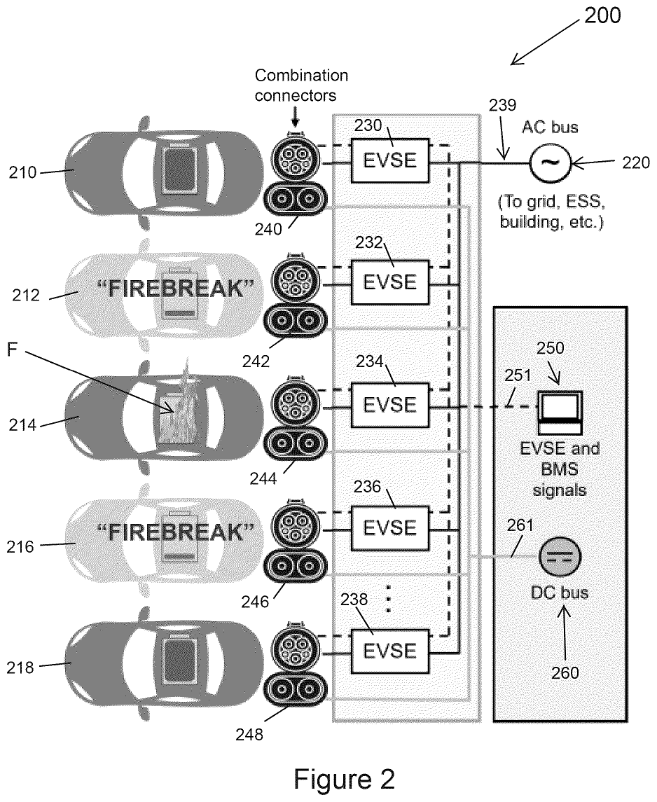

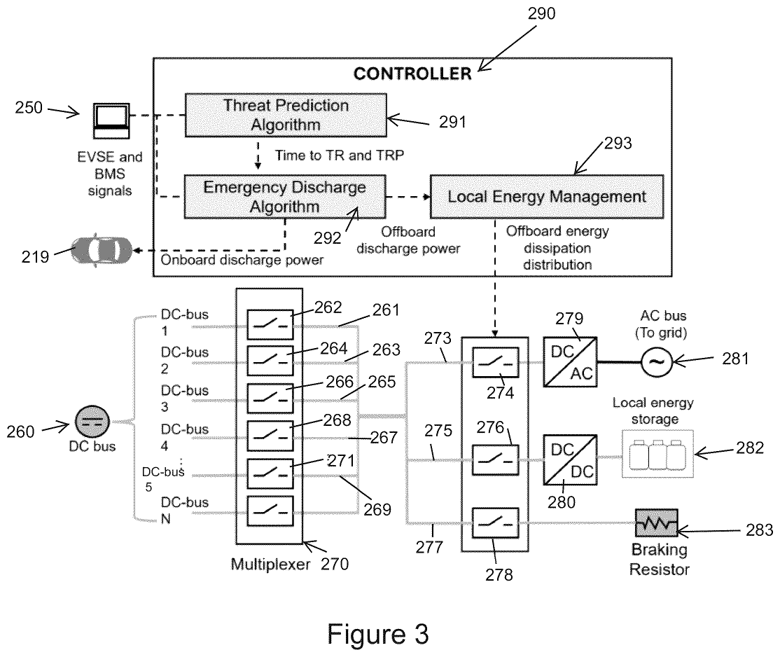

To execute an emergency discharge with existing EVSE technology, additional emergency EV discharge equipment is needed as illustrated in FIGS. 2 and 3. The main components include: (1) a controller to determine the discharge power and coordinate the power distribution, and (2) a large, high-power energy dissipation element to serve as the primary electrical load as seen in FIG. 3. As soon as a threat to the fleet of electric vehicles is detected, for example, an EV detects thermal runaway occurring in the battery pack, the EV will notify the charging station's emergency EV discharge equipment which can be relayed through the EVSE. The controller will begin discharging adjacent electric vehicles to create a firebreak and coordinate current distribution across onboard and offboard loads.

The controller can be a single controller overseeing the entire process or a distributed control system. The discharge rate can be determined based on the urgency of the threat, potentially requiring a fast discharge that pushes the battery pack to higher temperatures than normal operating conditions, but safely below the thermal runaway onset threshold. The urgency of the threat can be evaluated either by the EV's battery management system (BMS) or as part of the controller. Basic information communicated from the BMS (e.g., SOC, maximum temperature, gas concentration, air pressure, humidity, etc.) can be used to estimate safety metrics, such as time to thermal runaway and time to thermal runaway propagation through a model-predictive algorithm. The estimated safety metrics can be used to set the discharge rate while accounting for the availability and physical limitations of other onboard and offboard electrical loads. For a bidirectional EVSE, charger-integrated loads may include stationary energy storage (e.g., a battery bank or a supercapacitor bank), building, (micro-)grid, or other physically-distanced vehicles. Onboard vehicle loads include those that can be powered by the high-voltage bus, e.g., battery thermal management, cabin HVAC, motors, etc. If continuous voltage and temperature measurements are available from the BMS, the controller can use feedback control to moderate the discharge current and prevent the pack from violating electro-thermal-chemical safety constraints.

A large, high-power energy dissipation element, e.g., resistor bank or breaking resistor, can serve as the primary resistive heat dissipation to a structure fixture, optionally with its own cooling system or heat sink. The energy dissipation element can be installed with the EVSE to quickly and safely dissipate the energy.

Multiplexing hardware can enable the discharge equipment to be shared among multiple vehicles and chargers, reducing costs. The energy dissipation element(s) can be sized and configured to accommodate at least two commercial EVs discharging simultaneously, depending on the parking configuration. For existing EVSEs, this large energy dissipation element can be retrofitted and connected to bypass the EVSE's converters through a combination connector that integrates both DC and AC cables (e.g., SAE J1772 and SAE J3068). Under normal operation, the AC cables enable Level 2 EV charging. If a thermal runaway event is imminent, the AC charging is disabled and the discharge equipment is connected to the EV battery pack using the Level 3 DC cables. During normal operation, when EVSEs are unable to discharge energy to other assets, e.g., grid, building, energy storage, etc., the energy dissipation element can be used as a tool to discharge vehicles without having to drive the EV, for example, to safely handle and transport EVs for repairs or do prognostics such as draining the battery pack to determine the full pack energy capacity.

Turning now to FIG. 2, there is shown a non-limiting example embodiment of a charging station 200 that can be used for charging a plurality of electric vehicles 210, 212, 214, 216, 218. While five electric vehicles are shown, the charging station 200 may be configured to charge two or more vehicles. The charging station 200 includes an electrical source providing an alternating current power output, such as AC bus 220 (e.g., the electrical grid, an energy storage system having AC output, a building, etc.). Bidirectional charging dispensers 230, 232, 234, 236, 238 (electric vehicle supply equipment [EVSE]) are electrically connected with the electrical source 220 via electrical line 239. Each charging dispenser 230, 232, 234, 236, 238 includes a combination connector 240, 242, 244, 246, 248 that integrates a DC cable enabling Level 3 DC charging and an AC cable enabling Level 2 AC charging. An enlarged end view of each combination connector 240, 242, 244, 246, 248 is shown. Each of electric vehicles 210, 212, 214, 216, 218 includes a mating connector for its associated combination connector 240, 242, 244, 246, 248. Other connectors may also be suitable for connecting and thereafter charging the electric vehicles 210, 212, 214, 216, 218.

During operation of the charging station 200, heating of the battery pack of one or more of the electric vehicles 210, 212, 214, 216, 218 may cause the battery cells to overheat and cause battery thermal runaway, which can generate toxic smoke, fires, and explosions. In FIG. 2, the battery pack of electric vehicle 214 has undergone battery thermal runaway, which has generated a fire F. The fire F could cause the battery cells in the battery packs of neighboring electric vehicles 210, 212, 216, 218 to overheat and cause battery thermal runaway in the battery packs of neighboring electric vehicles 210, 212, 216, 218, which can generate even more toxic smoke, fires, and explosions. Advantageously, the charging station 200 includes features that prevent the fire F from propagating to all or part (e.g., the battery packs) of neighboring electric vehicles 210, 212, 216, 218, which are parked and optionally being charged in close proximity to electric vehicle 214 having the fire F.

Referring now to FIGS. 2 and 3, the charging station 200 includes a controller 290 having a microprocessor under the control of a software program stored in the memory of the controller 290. The controller 290 is in electrical communication with a computing device 250 for receiving EVSE and battery management system (BMS) signals from the computing device 250, which the receives EVSE and battery management system (BMS) signals from a battery management system of each of the electric vehicles 210, 212, 214, 216, 218. A temperature sensor is positioned in or adjacent the battery pack of each of the electric vehicles 210, 212, 214, 216, 218. The temperature sensor of each of the electric vehicles 210, 212, 214, 216, 218 is in electrical communication with the battery management system of each of the electric vehicles 210, 212, 214, 216, 218.

The controller 290 receives, from the battery management system of each of the electric vehicles 210, 212, 214, 216, 218, electrical signals based on readings from the temperature sensor of each of the electric vehicles 210, 212, 214, 216, 218. The electrical signals are passed to a threat detection algorithm 291 in the controller 290 to determine whether one or more of the electrical signals from a battery management system of one of the electric vehicles 210, 212, 214, 216, 218 exceeds a temperature threshold. In one embodiment, the controller 290 passes a battery pack operating characteristic received from the battery management system to a model in the threat detection algorithm 291 to estimate a safety metric for the battery pack of each of the electric vehicles 210, 212, 214, 216, 218. In one embodiment, the safety metric is a time to thermal runaway or a time to thermal runaway propagation for the battery pack of each of the electric vehicles 210, 212, 214, 216, 218. In one embodiment, the battery pack operating characteristic is selected from state of charge, maximum temperature, gas concentration, air pressure, humidity, or any combination thereof.

In the example embodiment of FIG. 2, the battery pack of electric vehicle 214 has undergone battery thermal runaway, which has generated the fire F. Due to the fire F in electric vehicle 214, electrical signals based on readings from the temperature sensor of electric vehicle 214 before the fire can indicate that the temperature threshold has been exceeded in the battery pack of electric vehicle 214. At the vehicle level, an emergency discharge can prevent a cascading EV-to-EV fire. Specifically, neighboring electric vehicles 210, 212, 216, 218, which are parked in close proximity to the electric vehicle 214 having the fire F, are potentially at high SOC and therefore, a fire could propagate to neighboring electric vehicles 210, 212, 216, 218. However, by discharging the battery pack of neighboring electric vehicles 210, 212, 216, 218, before the fire can propagate, the reduced heat generation may be low enough to prevent or at least slow the propagation. When one or more of the electrical signals from the battery management system of electric vehicle 214 exceeds the temperature threshold, the controller 290 sends signals to an emergency discharge algorithm 292 and/or a local energy management algorithm 293 such that electricity flows from the battery pack of neighboring electric vehicles 212, 216 to an energy dissipation element thereby creating a firebreak function in neighboring electric vehicles 212, 216. In one embodiment, the controller 290 executes the program stored in the controller to adjust a discharge rate from the battery pack of one or both of the neighboring electric vehicles 212, 216 to the energy dissipation element using a variable resistor based on a safety metric.

Still referring to FIGS. 2 and 3, the charging station 200 includes a DC bus 260 that is in electrical communication with the DC cable of each combination connector 240, 242, 244, 246, 248 that integrates the DC cable enabling Level 3 DC charging. The DC bus 260 enables the emergency discharge algorithm 292 and/or the local energy management algorithm 293 of the controller 290 to control discharge of the battery pack of any of the electric vehicles 210, 212, 214, 216, 218 to an energy dissipation element. Turning now to FIG. 3, the DC bus 260 includes DC-bus 1 in electrical communication with the battery pack of electric vehicle 210, DC-bus 2 in electrical communication with the battery pack of electric vehicle 212, DC-bus 3 in electrical communication with the battery pack of electric vehicle 214, DC-bus 4 in electrical communication with the battery pack of electric vehicle 216, DC-bus 5 in electrical communication with the battery pack of electric vehicle 218, and DC-bus N (which indicates that any number of electric vehicles can be present in charging station 200). DC-bus 1, DC-bus 2, DC-bus 3, DC-bus 4, DC-bus 5 and DC-bus N (if present) are in electrical communication with a multiplexer 270 that includes electrical switches 262, 264, 266, 268, 271 that, under control of the controller 290, selectively control flow of electricity from DC-bus 1, DC-bus 2, DC-bus 3, DC-bus 4, and DC-bus 5 to associated electrical lines 261, 263, 265, 267, 269, respectively. The electrical lines 261, 263, 265, 267, 269 are in electrical communication with electrical lines 273, 274, 275 that are in electrical communication with electrical switches 274, 276, 278 that are under control of the controller 290. Electrical switch 274 is in electrical communication with a DC-AC inverter 279 and an AC bus 281 (e.g., electrical grid) serving as an energy dissipation element. Electrical switch 276 is in electrical communication with a DC-DC transformer and local energy storage 282 (e.g., a battery energy storage system) serving as an energy dissipation element. Electrical switch 278 is in electrical communication with a braking resistor 283 serving as an energy dissipation element. The AC bus 281, local energy storage 282, and braking resistor 283, alone or in any combination, can serve as an energy dissipation element for offboard energy dissipation distribution as shown in FIG. 3. Also, auxiliary vehicle 219 (which may or may not be charging) can serve as an energy dissipation element for onboard discharge power as shown in FIG. 3.

When one or more of the electrical signals from the battery management system of one of the electric vehicles 210, 212, 214, 216, 218 exceeds a temperature threshold (as detailed above), the controller 290 sends signals to the emergency discharge algorithm 292 and/or the local energy management algorithm 293 such that electricity flows from the battery pack of one or more neighboring electric vehicles to one, two, three, or all of the energy dissipation elements 219, 281, 282, 283 thereby creating a firebreak function in one or more neighboring electric vehicles. FIG. 2 shows one non-limiting example wherein one or more of the electrical signals from the battery management system of electric vehicle 214 exceeds a temperature threshold and the controller 290 sends signals to the emergency discharge algorithm 292 and/or the local energy management algorithm 293 such that electricity flows from the battery pack of neighboring electric vehicles 212, 216 to one, two, three, or all of the energy dissipation elements 219, 281, 282, 283 thereby creating a firebreak function in neighboring electric vehicles 212, 216. In another non-limiting example, one or more of the electrical signals from the battery management system of electric vehicle 210 exceeds a temperature threshold and the controller 290 sends signals to the emergency discharge algorithm 292 and/or the local energy management algorithm 293 such that electricity flows from the battery pack of neighboring electric vehicle 212 to one, two, three, or all of the energy dissipation elements 219, 281, 282, 283 thereby creating a firebreak function in neighboring electric vehicle 212. In another non-limiting example, one or more of the electrical signals from the battery management system of electric vehicle 214 exceeds a temperature threshold and the controller 290 sends signals to the emergency discharge algorithm 292 and/or the local energy management algorithm 293 such that electricity flows from the battery pack of neighboring electric vehicles 210, 212, 216, 218 to one, two, three, or all of the energy dissipation elements 219, 281, 282, 283 thereby creating a firebreak function in neighboring electric vehicles 210, 212, 216, 218. In one embodiment, a communication signal can initiate the emergency discharge algorithm 292 and/or the local energy management algorithm 293.

As noted above, each of the charging dispensers 230, 232, 234, 236, 238 can be configured to electrically connect with a combination connector 240, 242, 244, 246, 248 that integrates a DC cable enabling Level 3 DC charging and an AC cable enabling Level 2 AC charging. When electricity flows from the battery pack of one or more of the electric vehicles 210, 212, 214, 216, 218 to an energy dissipation element 219, 281, 282, 283 via the DC cable of one or more of the combination connectors 240, 242, 244, 246, 248, AC charging is disabled to the associated electric vehicle. One or more of the electric vehicles 210, 212, 214, 216, 218 can be connected to the discharge equipment (e.g., one or more of the energy dissipation elements 219, 281, 282, 283) via a combination connector 240, 242, 244, 246, 248, such that the electrical connections and, ultimately current, can bypass the charger if needed.

Thus, the present invention provides emergency electric vehicle discharge equipment for discharging one or more battery packs in electric vehicles parked and optionally being charged in a charging station, and methods for discharging one or more battery packs in electric vehicles parked and optionally being charged in a charging station.

In light of the principles and example embodiments described and illustrated herein, it will be recognized that the example embodiments can be modified in arrangement and detail without departing from such principles. Also, the foregoing discussion has focused on particular embodiments, but other configurations are also contemplated. In particular, even though expressions such as “in one embodiment”, “in another embodiment”, “in certain embodiments”, or the like are used herein, these phrases are meant to generally reference embodiment possibilities, and are not intended to limit the invention to particular embodiment configurations. As used herein, these terms may reference the same or different embodiments that are combinable into other embodiments. As a rule, any embodiment referenced herein is freely combinable with any one or more of the other embodiments referenced herein, and any number of features of different embodiments are combinable with one another, unless indicated otherwise.

Although the invention has been described in considerable detail with reference to certain embodiments, one skilled in the art will appreciate that the present invention can be practiced by other than the described embodiments, which have been presented for purposes of illustration and not of limitation. Therefore, the scope of the appended claims should not be limited to the description of the embodiments contained herein. Various features and advantages of the invention are set forth in the following claims.

1. A charging station for charging a plurality of electric vehicles, the charging station comprising:
an electrical source providing an alternating current power output;
a charging dispenser electrically connected with the electrical source, the charging dispenser configured to electrically connect with each of the plurality of electric vehicles to optionally charge a battery pack of each of the plurality of electric vehicles via the alternating current power output from the electrical source, each of the plurality of electric vehicles including a battery management system and a sensor in or adjacent the battery pack of each of the plurality of electric vehicles, the sensor of each of the plurality of electric vehicles being in electrical communication with the battery management system of each of the plurality of electric vehicles;
an energy dissipation element, wherein the battery pack of each of the plurality of electric vehicles is in a circuit path with the energy dissipation element when the charging dispenser is electrically connected with each of the plurality of electric vehicles, each circuit path including a switch having a first position in which electricity does not flow from the battery pack of each of the plurality of electric vehicles to the energy dissipation element and a second position in which electricity flows from the battery pack of each of the plurality of electric vehicles to the energy dissipation element, each switch being in the first position when the charging dispenser is electrically connected with each of the plurality of electric vehicles; and
a controller in electrical communication with the battery management system of each of the plurality of electric vehicles and each of the switches, the controller being configured to execute a program stored in the controller to:
(i) receive, from the battery management system of each of the plurality of electric vehicles, electrical signals based on readings from the sensor of each of the plurality of electric vehicles,
(ii) determine whether one or more of the electrical signals from a battery management system of one of the plurality of electric vehicles exceeds a safety threshold, and
(iii) when the one or more of the electrical signals from the battery management system of the one of the plurality of electric vehicles exceeds the safety threshold, move the switch in the circuit path in another of the plurality of electric vehicles to the second position such that electricity flows from the battery pack of the another of the plurality of electric vehicles to the energy dissipation element.

2. The charging station of claim 1 wherein:
the another of the plurality of electric vehicles is adjacent to the one of the plurality of electric vehicles.

3. The charging station of claim 1 wherein:
the sensor comprises a temperature sensor, and
the safety threshold comprises a temperature threshold that indicates thermal runaway of the battery pack of the one of the plurality of electric vehicles.

4. The charging station of claim 1 wherein:
the controller executes the program stored in the controller to:
(iv) when the one or more of the electrical signals from the battery management system of the one of the plurality of electric vehicles exceeds the safety threshold, move the switch in the circuit path in an additional one of the plurality of electric vehicles to the second position such that electricity flows from the battery pack of the additional one of the plurality of electric vehicles to the energy dissipation element.

5. The charging station of claim 4 wherein:
the additional one of the plurality of electric vehicles is adjacent to the one of the plurality of electric vehicles,
the another of the plurality of electric vehicles is on a first side of the one of the plurality of electric vehicles, and
the additional one of the plurality of electric vehicles is on an opposite second side of the one of the plurality of electric vehicles.

6. The charging station of claim 1 wherein:
each circuit path includes a variable resistor in electrical communication with the controller, and
the controller executes the program stored in the controller to adjust the variable resistor such that a discharge rate from the battery pack of the another of the plurality of electric vehicles to the energy dissipation element is below a thermal runaway onset threshold for the battery pack of the another of the plurality of electric vehicles.

7. The charging station of claim 1 wherein:
the energy dissipation element comprises an electrical grid.

8. The charging station of claim 1 wherein:
the energy dissipation element comprises an energy storage system.

9. The charging station of claim 1 wherein:
the energy dissipation element comprises a resistor.

10. The charging station of claim 1 wherein:
the energy dissipation element comprises an electrical device of an auxiliary electrical vehicle.

11. The charging station of claim 1 wherein:
the charging dispenser is configured to electrically connect with a combination connector of each of the plurality of electric vehicles, and
each combination connector integrates a DC cable enabling DC charging and an AC cable enabling AC charging, and
when the switch in the circuit path in the another of the plurality of electric vehicles is in the second position, electricity flows from the battery pack of the another of the plurality of electric vehicles to the energy dissipation element via the DC cable of the combination connector of the another of the plurality of electric vehicles.

12. The charging station of claim 11 wherein:
when the one or more of the electrical signals from the battery management system of the one of the plurality of electric vehicles exceeds the safety threshold, AC charging is disabled to the another of the plurality of electric vehicles and the electricity flows from the battery pack of the another of the plurality of electric vehicles to the energy dissipation element via the DC cable of the combination connector of the another of the plurality of electric vehicles.

13. The charging station of claim 11 further comprising:
an energy management device having (i) a first conducting path in which electricity flows from the battery pack of the another of the plurality of electric vehicles to the energy dissipation element, (ii) a second conducting path in which electricity flows from the battery pack of the another of the plurality of electric vehicles to a second energy dissipation element, and (iii) a third conducting path in which electricity flows from the battery pack of the another of the plurality of electric vehicles to a third energy dissipation element,
wherein the energy dissipation element comprises an electrical grid, the second energy dissipation element comprises an energy storage system, and the third energy dissipation element comprises a resistor, and
wherein the energy management device is configured to selectively deliver electricity from the battery pack of the another of the plurality of electric vehicles to one or more of the energy dissipation element, the second energy dissipation element, and the third energy dissipation element.

14. The charging station of claim 1 wherein:
the first conducting path includes a DC-AC inverter.

15. The charging station of claim 1 wherein:
the controller executes the program stored in the controller to pass a battery pack operating characteristic received from the battery management system of each of the plurality of electric vehicles into a model to estimate a safety metric for the battery pack of each of the plurality of electric vehicles.

16. The charging station of claim 15 wherein:
the safety metric is a time to thermal runaway or a time to thermal runaway propagation for the battery pack of each of the plurality of electric vehicles.

17. (canceled)

18. (canceled)

19. The charging station of claim 1 wherein:
the charging dispenser comprises a plurality of charging dispensers, each charging dispenser being electrically connected with the electrical source and an associated one of the plurality of electric vehicles.

20. The charging station of claim 1 further comprising:
a multiplexer that enables the energy dissipation element to be shared among each of the plurality of electric vehicles.

21. The charging station of claim 1 further comprising:
a cooling system in thermal communication with the energy dissipation element.

22. A method for preventing cascading fires in a charging station for charging a plurality of electric vehicles, the method comprising:
(a) providing a sensor in a battery pack of each of the plurality of electric vehicles, the sensor of each of the plurality of electric vehicles being in electrical communication with a battery management system of each of the plurality of electric vehicles, the battery pack of each of the plurality of electric vehicles being in a circuit path with an energy dissipation element, each circuit path including a switch having a first position in which electricity does not flow from the battery pack of each of the plurality of electric vehicles to the energy dissipation element and a second position in which electricity flows from the battery pack of each of the plurality of electric vehicles to the energy dissipation element;
(b) electrically connecting each of the plurality of electric vehicles to a charging dispenser of the charging station, each switch being in the first position when the charging dispenser is electrically connected with each of the plurality of electric vehicles;
(c) receiving, in a controller in electrical communication with the battery management system of each of the plurality of electric vehicles, electrical signals based on readings from the sensor of each of the plurality of electric vehicles;
(d) determining in the controller whether one or more of the electrical signals from a battery management system of one of the plurality of electric vehicles exceeds a safety threshold; and
(e) when the one or more of the electrical signals from the battery management system of the one of the plurality of electric vehicles exceeds the safety threshold, moving the switch in the circuit path in another of the plurality of electric vehicles to the second position such that electricity flows from the battery pack of the another of the plurality of electric vehicles to the energy dissipation element.

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

36. (canceled)

37. (canceled)

38. (canceled)

39. (canceled)

40. (canceled)
